(19) United States
(12) Patent Application Publication
(10) Pub. No.: US 2008/0271919 A1
(43) Pub. Date: Nov. 6, 2008

(54) BUNDLED COMPOSITE CABLE WITH NO OUTER OVER-JACKET

(76) Inventor: Joe ELKO, Hickory, NC (US)

Correspondence Address: Muncy, Geissler, Olds & Lowe, PLLC, P.O. BOX 1364, FAIRFAX, VA, 22038-1364, US

(21) Appl. No.: 11/743,077

(22) Filed: May 1, 2007

(51) Int. Cl. H02G 3/00; H01B 7/00

(52) U.S. Cl. 174/70 C

(57) ABSTRACT

A composite cable is formed by wrapping plural separately jacketed cables in a helical fashion by an outer containment element, such as a jacket formed as a strip of material. Air gaps may exist between wound strands of the outer jacket to expose the inner cables. Two or more strip-like outer jackets may be helically wound about the plural cables in opposing directions wherein one outer jacket overlaps the other outer jacket. Alternatively, the two outer jackets may overlap and underlap each other and form a basket weave pattern. The outer jacket material may be stored on a spool and unwound to helically wrap the bundled cables.

### BACKGROUND OF THE INVENTION

1. Field of the Invention

The present invention relates to communication cables. More particularly, the present invention relates to composite cables, wherein two or more jacketed cables are combined within a common outer jacket to create a special purpose composite cable.

2. Description of the Related Art

In the communications industry, special purpose composite cables are often desired by customers to satisfy particular needs. For example, a customer might require a communication cable package to run from a business's utility closet on a first floor corner of the building to a computer networking closet in the center of the fifteenth floor of the building. The desired communication cable package might include two coaxial cables (one for cable television and one for a security camera), one twisted pair cable (for telephone services), and a fiber optic cable (for a high speed internet connection). Such a special purpose cable package is sometimes referred to as a composite cable.

FIG. 1 is depicts a composite cable 11 in accordance with the prior art which would satisfy the hypothetical customer's desires. The composite cable 11 includes an outer jacket 12 surrounding a first coaxial cable 13, a second coaxial cable 14, a twisted pair cable 15, and a fiber optic cable 16. Each of the inner cables 13-16 within the composite cable 11 usually includes its own jacket, as each cable was typically previously manufactured for independent usage. Further, the jackets on the inner cables 13-16 assist in preventing the inner cables 13-16 from interfering with the performance characteristics of one another. The jackets on the inner cables 13-16 typically include printed indicia on the outer surfaces thereof, such as an identity of a manufacturer, a cable type or performance criteria identification, a batch number or manufacture date, and a length measurement.

The outer jacket 12 of the composite cable 11 packages the inner cables 13-16. This simplifies the installation process at the customer end. This is the primary advantage of the composite cable 12 in that only the single composite cable 11 needs to be strung or pulled from the source area to the destination area, instead of installing four separate cables 13-16 to meet the customer's needs.

Other types of composite cables besides the composite cable 11, as illustrated in FIG. 1, are also known in the prior art. For example, satellite TV coaxial cable is available as a twin cable. In a twin coaxial cable, two separately jacketed coaxial cables are bonded together by a thin strip of jacketing material. No outer jacket 12 surrounds the two coaxial cables. The two coaxial cables may be run side-by-side from a source area to a destination area and then manually pulled apart by tearing the thin strip of jacket material between the two cables, so that the two terminals at the ends of the two coaxial cables may be connected to two separated connectors.

Another similar type of composite cable is sold under the name Banana Peel® and manufactured by BELDON/CDT. The Banana Peel® composite cable includes a center spline to which multiple jacketed cables (e.g. 3, 5 or 6 cables) are adhered or bonded. No outer jacket 12 surrounds the multiple cables. The cables package may be run from a source area to a destination area and then manually pulled apart by tearing each cable away from the center spline, much like peeling a banana where the cables are the banana's skin and the center spline is the banana's fruit.

### SUMMARY OF THE INVENTION

The Applicant has appreciated one or more drawbacks associated with the designs of the prior art.

Regarding the prior art composite cable of FIG. 1, the outer jacket 12 consumes a large amount material. For example, about seventy-five pounds of material are used in forming the outer jacket 12 for one thousand feet of a composite cable 11 including seven coaxial cables. Such outer jacket material adds to the cost of the composite cable 11, adds to the weight and volume of the composite cable 11 (which increases transportation and storage costs), and provides more overall material to burn and emit smoke and gases in the case of a fire. Further, the outer jacket 12 reduces the flexibility of the composite cable 11, which makes the installation process more difficult.

The Applicant has also appreciated drawbacks to the prior art of twin cables and multiple cables adhered to a center spline. Basically, there are limits to the number of cables which can be extruded side-by-side in the case of twin cables. There are also limits to the number of cables which can be attached to a center spline. In order to increase the number of cables to be adhered to a center spline, the size of the center spline must be increased to expand the outer surface area thereof. The center spline adds one more element to the composite cable which extends in the same direction of the cables, and hence the center spline increases the rigidity of the overall composite cable.

Further, the center spline is covered by the cables adhered thereto, and hence the center spline is not visible along the length of the composite cable. It would be advantageous to have some outer surface which would be visible to the user to display indicia, such as an identity of a manufacturer of the composite cable, a part number of the composite cable, a batch number or manufacture date for the composite cable, and a length measurement.

The Applicant has also appreciated a need in the art for a composite cable which is simple in design, rugged, lighter weight, more flexible, easy to manufacture and/or less expensive to manufacture.

It is an object of the present invention to address one or more of the drawbacks of the prior art composite cables and/or Applicant's appreciated needs in the art.

Embodiments of the present invention include a composite cable formed by combining plural separately jacketed cables into a bundle. The separate cables are wrapped in a helical fashion by an outer containment element, such as a jacket formed as a strip of material. Air gaps may exist between wound strands of the outer jacket to expose the inner cables. Two or more strip-like outer jackets may be helically wound about the plural cables in opposing directions wherein one outer jacket overlaps the other outer jacket. Alternatively, the two outer jackets may overlap and underlap each other and form a basket weave pattern. The outer jacket material may be stored on a spool and unwound to helically wrap the bundled cables.

These and other objects are accomplished by a composite cable comprising: a first jacketed cable; a second jacketed cable; and an outer containment element continuously wound about said first and second jacketed cables, wherein a surface of said outer containment element facing said first and second jacketed cables is at least partially adhered to said first and second jacketed cables.

Also, these and other objects are accomplished by a composite cable comprising: a first jacketed cable; a second jacketed cable; a first outer containment element continuously wound about said first and second jacketed cables, which is wound in a first rotating direction about said first and second jacketed cables; and a second outer containment element continuously wound about said first and second jacketed cables, which is wound in a second rotating direction about said first and second jacketed cables, wherein said second rotating direction is opposite to said first rotating direction.

Furthermore, these and other objects are accomplished by a method of forming a composite cable comprising: unspooling a first jacketed cable; unspooling a second jacketed cable; bringing the first and second jacketed cables into close proximity or abutment; moving the first and second jacketed cables past wrapping equipment; and unspooling a preformed strip of outer containment material onto an external surface of the first and second jacketed cables in a helical manner so as to create strands of outer containment material winding around the first and second jacketed cables.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limits of the present invention, and wherein:

FIG. 1 is a perspective view of a composite cable, in accordance with the prior art;

FIG. 2 is a perspective view of a composite cable, in accordance with a first embodiment of the present invention;

FIG. 3 is a cross sectional view of an outer jacket wrap material in accordance with a first embodiment of the invention;

FIG. 4 is a cross sectional view of an outer jacket wrap material in accordance with a second embodiment of the invention;

FIG. 5 is a perspective view of a composite cable, in accordance with a second embodiment of the present invention;

FIG. 6 is a schematic illustration of manufacturing equipment for creating the composite cable of FIG. 2; and

FIG. 7 is a schematic illustration of manufacturing equipment for creating the composite cable of FIG. 5.

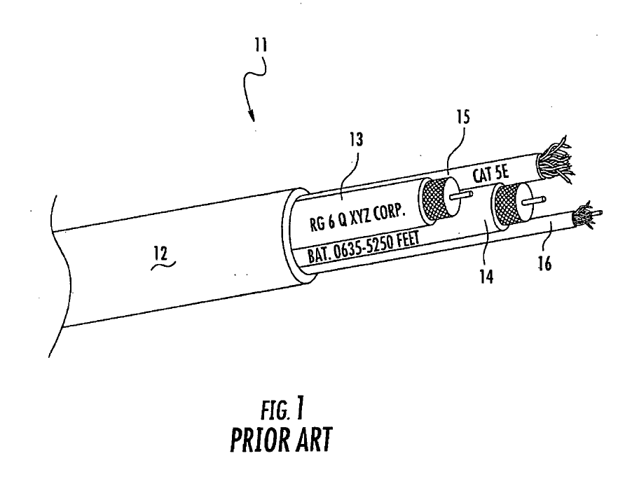

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

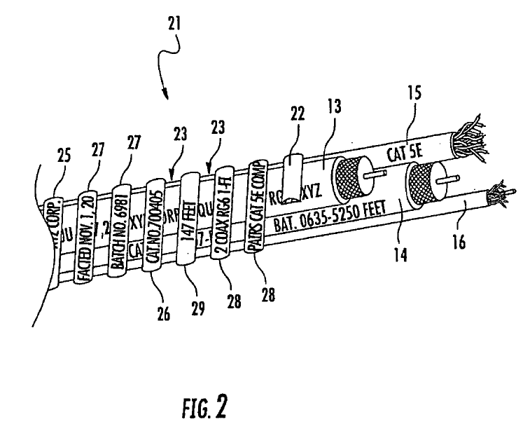

A composite cable 21 in accordance with the present invention is illustrated in FIG. 2. The composite cable 21 includes an outer containment element, such as an outer jacket 22 wrapping the first coaxial cable 13, the second coaxial cable 14, the twisted pair cable 15, and the fiber optic cable 16. Each of the inner cables 13-16 within the composite cable 21 usually includes its own jacket, as each cable was typically previously manufactured for independent usage. The jackets on the inner cables 13-16 typically include printed indicia on the outer surfaces thereof, such as an identity of a manufacturer, a cable type or performance criteria identification, a batch number or manufacture date, and a length measurement.

Although FIG. 2 illustrates four inner jacketed cables 13-16, it should be appreciated and any number of inner jacketed cables could be included in the composite cable 21, such as two cables, three cables, or five or more cables. Also, FIG. 2 illustrates two coaxial cables, one twisted pair cable, and one fiber optic cable. Other combinations of cables could be included in the composite cable 21, such as six coaxial cables and no fiber optic cables or twisted pair cables.

As can be seen in FIG. 2, the outer jacket 22 is continuously wound about the inner jacketed cables 13-16 in a helical fashion. In a preferred embodiment, adjacent wound strands of the outer jacket 22 are spaced from one another so as to create a helix with air gaps 23 exposing the inner jacketed cables 13-16. As illustrated in FIG. 2, the air gaps 23 result in an outer appearance of the composite cable 21 exhibiting less than about 50% of a material used to form the outer jacket 22 and more than about 50% air gaps 23 exposing the inner jacketed cables 13-16.

The air gaps 23 provide several advantages. First, the material used to form the outer jacket 12 in accordance with the prior art composite cable 11 is greatly reduced, such as by 50% or more. Hence, the composite cable 21 is lighter in weight, less expensive to manufacture, and has less material to burn in the case of a fire. Also, the somewhat perpendicular orientation of the air gaps 23 increases the flexibility of the composite cable 21, as compared to a solid jacket 12 or a center spline.

Further, reducing the material used in forming the outer jacket material 22 can lead to reduced signal attenuation within the electrical signal carrying inner jacketed cables, such as the twisted pair cable 15. This is because the dielectric value of air is lower than the dielectric value of the material used to form the outer jacket 22, so by placing more air immediately adjacent to the jacketed twisted pair cable 15, less signal attenuation should occur as compared to the composite cable 11 of the prior art. Moreover, the spiraling configuration of the outer jacket 22 serves somewhat like fins to ensure that the twisted pair cable 15 in the composite cable 21 is spaced by a distance at least equal to the thickness (t) of the outer jacket 22 from electrical noise sources. This will reduce the likelihood of alien crosstalk occurring within the twisted pair cable 15, as compared to the Banana Peel® composite cable.

Another advantage is that a technician inspecting the composite cable 21 somewhere between its beginning point and ending point can see through the air gaps 23 and gain a quick understanding of the number and types of inner cables 13-16. With the outer jacket 12 of the prior art composite cable 11, this was not possible, as the outer jacket 12 completely covered the inner jacketed cables 13-16.

Yet another advantage of the outer jacket 22 of FIG. 2 is that indicia may be printed on the outer surface 24 of the outer jacket 22. The indicia may include information relating to a manufacturer 25 of the composite cable 21, a catalog number 26 of said composite cable 21, a manufacture date or batch number 27 of the composite cable 21, a performance rating or type 28 of one or more of the inner jacketed cables 13-16, and length measurements 29 along the composite cable 21. The length measurements 29 do not indicate the length of the outer jacket 22 which is helically wrapped, but rather indicate the linear length of the entire composite cable 21. For example, it may take three or four feet of outer jacket 22 to helically wrap one foot of composite cable 21.

Although FIG. 2 illustrates a material savings of about 50% for the outer jacket 22, as compared to the outer jacket 12 of the composite cable 11 of the prior art, it should be understood that greater material savings could be accomplished by expanding the size of the air gaps 23 between wound strands of the outer jacket 22. For example, savings in outer jacket material of 75% or greater would be possible.

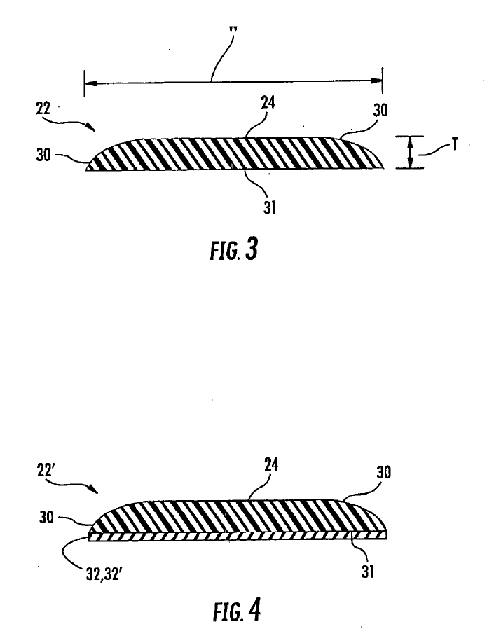

The outer jacket 22 may be formed of any typical cable jacket material; however, polymer materials such as polyvinylchloride (PVC), flame retardant polyvinylchloride (FR-PVC), and polyvinylchloride fluoride (PVDF) are particularly advantageous in forming the outer jacket 22. In a preferred embodiment as illustrated in the cross sectional view of FIG. 3, the outer jacket 22 has a radial thickness (t) of about 20 mils and a width (w) of about ¼ inch. However, other thicknesses (t) and widths (w) are within the scope of the present invention.

Also, as illustrated in FIG. 3, the side edges of the outer jacket 22 include a radius 30 transitioning to the outer surface 24. The radius 30 assists in pulling/running the composite cable 21 through holes or past obstructions during the installation process. Although a radius 30 has been illustrated on the side edges in FIG. 3, it would be possible to form the outer jacket 22 without a radius 30 on one or both of the side edges and still achieve the primary benefits of the invention.

In a preferred embodiment, an inner surface 31 of the outer jacket 22 facing the inner jacketed cables 13-16 is at least partially adhered to the jackets of the inner jacketed cables 13-16. In a first embodiment, the inner surface 31, which is formed of a polymer, is directly bonded to the jackets of the inner jacketed cables 13-16. The bonding could occur by applying the outer jacket 22 onto the inner jacketed cables 13-16, while the outer jacket 22 is in a heated state or by heating the outer jacket 22 after it is applied to the inner jacketed cables 13-16, as will be more fully described below in conjunction of the method of manufacturing descriptions.

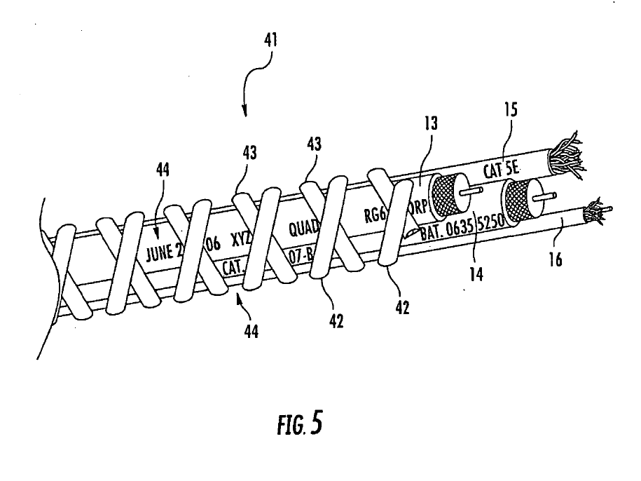

FIG. 4 illustrates a second embodiment of the outer jacket 22′. The outer jacket 22′ includes an adhesive layer 32 or 32′ applied to the inner surface 31 in the form of a heat sensitive layer 32 or a contact pressure sensitive layer 32′. The adhesive layer 32 or 32′ preferably does not adhere to the upper surface 24 so as to permit spooling of the outer jacket 22 before it is helically wrapped about the inner cables 13-16. The outer surface 24 may be coated with layer of material to reduce adhesion so as to permit spooling, and/or the adhesive layer 32, 32′ may be designed to become adhesive only upon a certain level of contact pressure, or more preferably after a certain temperature is surpassed. The functions of the adhesive layer 32, 32′ will also be more fully described below in conjunction of the method of manufacturing descriptions.

FIG. 5 illustrates a composite cable 41 in accordance with a second embodiment of the present invention. The composite cable 41 includes a first outer jacket 42 and a second outer jacket 43 surrounding the first coaxial cable 13, the second coaxial cable 14, the twisted pair cable 15, and the fiber optic cable 16.

As in FIG. 2, each of the inner cables 13-16 within the composite cable 21 usually includes its own jacket, as each cable was typically previously manufactured for independent usage. The jackets on the inner cables 13-16 typically include printed indicia on the outer surfaces thereof, such as an identity of a manufacturer, a cable type or performance criteria identification, a batch number or manufacture date, and a length measurement.

Although FIG. 5 illustrates four inner jacketed cables 13-16, it should be appreciated and any number of inner jacketed cables could be included in the composite cable 21, such as two cables, three cables, or five or more cables. Also, FIG. 5 illustrates two coaxial cables, one twisted pair cable, and one fiber optic cable. Other combinations of cables could be included in the composite cable 21, such as six coaxial cables and no fiber optic cables or twisted pair cables.

In the composite cable 41 of FIG. 5, the first outer jacket 42 is wound about the inner jacketed cables 13-16 in a first direction of rotation, e.g. clockwise as viewed from the right side of FIG. 5 looking to the left side. The second outer jacket 43 in wound about the inner jacketed cables 13-16 in an opposite direction of rotation, e.g. counter-clockwise as viewed from the right side of FIG. 5 looking to the left side.

The second outer jacket 43 may always overlap the first outer jacket 42. Alternatively, the second outer jacket 43 may alternatively overlap and underlap the first outer jacket 42 to create a basket weave pattern. For example, the second outer jacket 43 underlaps the first outer jacket 42 on the side of the composite cable 41 visible in FIG. 5, but would overlap the first outer jacket 42 on the backside of the composite cable 41 (which is not visible in FIG. 5). This configuration would be a form of a basket weave pattern, which creates air gaps 44 exposing the inner jacketed cables 13-16. A basket weave pattern is not necessarily an overlap followed sequentially by an underlap, but could include other intertwining patterns. As illustrated in FIG. 5, an outer appearance of the composite cable 41 exhibits less than about 50% of a material used to form the first and second outer jackets 42 and 43 and more than about 50% air gaps 44 exposing the inner jacketed cables 13-16.

Although FIG. 5 illustrates first and second outer jackets 42 and 43, it should be appreciated that more outer jackets could be included in a basket weave pattern. One advantage to the basket weave pattern is that it may no longer be required to bond the inner surfaces 31 of the first and second jackets 42 and 43 to the jackets of the inner jacketed cables 13-16. For example, if a sufficient number of outer jackets 42 and 43 are included, the mutual friction between the overlapping and underlapping of the outer jackets in a basket weave pattern could be sufficient to stop the unraveling of the outer jackets from the inner jacketed cables 13-16 absent any adhesion between the inner surface 31 of the outer jackets 42 and 43 and the jackets of the inner jacketed cables 13-16. However, it is still within the purview of the present invention that an adhesion or bonding of the outer jackets to the jackets of the inner jacketed cables 13-16 could be used in combination with the basket woven patterns of multiple outer jackets.

In order to simplify the illustration, FIG. 5 does not show indicia being printed on the first or second outer jackets 42 or 43. However, indicia may be printed on one or more of the outer jackets 42 and 43 to indicate information consistent with the information described in conjunction with FIG. 2.

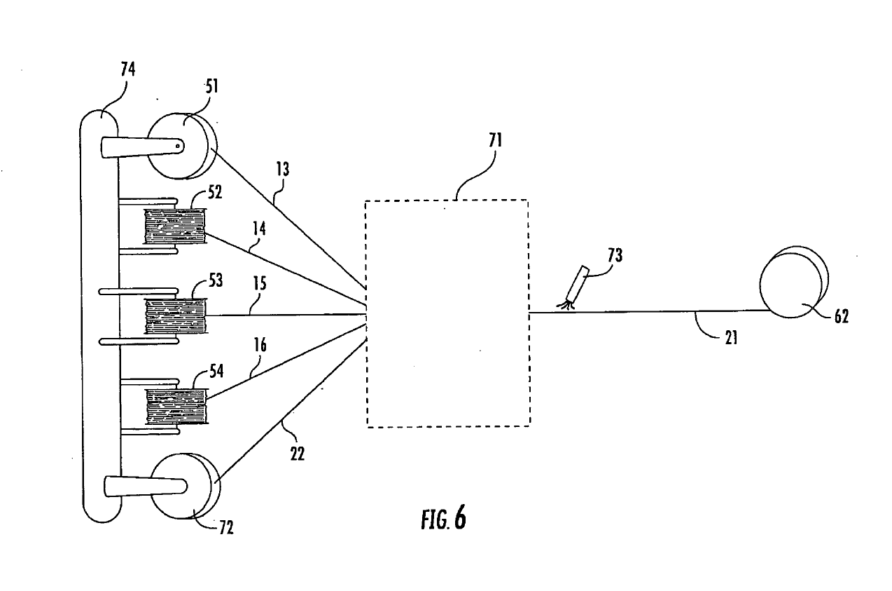

FIG. 6 is a schematic illustration of manufacturing equipment for creating the composite cable 21 of FIG. 2. At present, the equipment of FIG. 6 is the preferred method of forming the composite cable 21. As illustrated in FIG. 6, first through fourth jacketed cables 13-16 are being unspooled from first through fourth cable spools 51-54. The preformed outer jacket 22 is being unspooled from a fifth spool 72. The first through fifth spools 51, 52, 53, 54, and 72 are mounted to a ring 74, which can optionally move. The first through fourth jacketed cables 13-16 and outer jacket 22 are fed into wrapping equipment 71, such as a SZ stranding or twisting machine.

The SZ stranding machine is a known piece of equipment in the cable manufacturing art. SZ stranding machines are manufactured by such companies as NEXTROM of Concord Ga., TENSOR MACHINERY, LTD of Quebec Canada and/or SIEMENS AKTIENGESELLSCHAFT of Berlin and Munich, Germany. Numerous U.S. patents described the structural details of a SZ stranding machine or similar types of twisting machines, such as U.S. Pat. Nos. 6,634,164; 6,543,213; 5,966,216; 5,599,660; 4,813,233; 4,773,207; 4,586,327; 4,528,810; 4,493,182; 4,467,596; 4,386,496; 4,365,469; 4,359,857; and 4,328,664. Reference can be had to these prior U.S. patents for the structural details of the known SZ stranding machines, which are herein incorporated by reference. The illustration of the ring 74 supporting the spools 51, 52, 53, 54 and 72 is only schematic and may be a part of the SZ stranding machine. The SZ stranding machine may optionally control the spools 51, 52, 53, 54 and 72 to swivel, rotate, translate, reciprocate and crossover each other as needed to avoid kinking and twisting of the unspooled materials. Again, the SZ stranding machine is generally known in the cabling art and used for forming such structures as woven shielding layers on coaxial cables, constructing twisted pair cables, and twisting strength members of fiber optic cables. Such a SZ stranding machine and similar types of twisting machines are also known in the textile art and are used to form ropes and shoe laces.

The SZ stranding machine helically twists the outer jacket material 22 around the first through fourth jacketed cables 13-16, and can also optionally twist the first through fourth jacketed cables 13-16 about themselves, if desired. SZ stranding machines have adjustments, such that the air gaps between the helically wound strand of outer jacket 22 can be adjusted as desired.

Next, the outer jacket 22 wrapping the composite cable 21 is optionally heated by one or more heat sources, such as flame streams 73 on the downstream side of the SZ stranding machine. The heat of the flame streams 73 causes the outer jacket 22 to bond to the jackets of the inner jacketed cables 13-16, which are formed of a same or like material. Moreover, the heat sensitive adhesive layer 32 may also be provided on the spooled outer jacket 22 to assist the bonding process between the outer jacket 22 and the jackets of the inner jacketed cables 13-16.

After leaving the heat streams 73, the composite cable 21 is optionally passed though a cool water bath to cool the heated outer jacket 22, or directly spooled onto a take-up spool 62 for shipping to a customer or for later processing into customer packaging.

As an alternative, the heat sensitive layer 32 may be replaced by the pressure sensitive layer 32′. The SZ stranding machine may induce a certain level of tension on the outer jacket 22 as it is wrapped about the inner jacketed cables 13-16. The tension can serve to activate the pressure sensitive layer 32′ on the inner surface 31 of the outer jacket 22. In the alternative embodiment, the flame streams 73 and the cool water bath are not necessary. Rather, the composite cable 21 may be directly spooled onto the take-up spool 62 for shipping to a customer or for later processing into customer packaging.

The wrapping equipment 71 need not be a SZ stranding machine. Rather, the wrapping equipment 71 may be replaced by other known types of equipment used to wrap moving strands, such as wrapping equipment with a rotating payoff (e.g., the mount of one or more spools 51, 52, 53, 54 and 72 rotates about a point along the moving bundle of cables) and wrapping equipment with a rotating take-up (e.g., the mounts for the spools 51, 52, 53, 54 and 72 are stationary and the payoff of one or more spools passes through a feed guide, such as a collar, which rotates about a point along the moving bundle of cables). Again, such wrapping machines are known in the art of cable manufacturing, but have not previously been employed in the manufacturing of a composite cable 21.

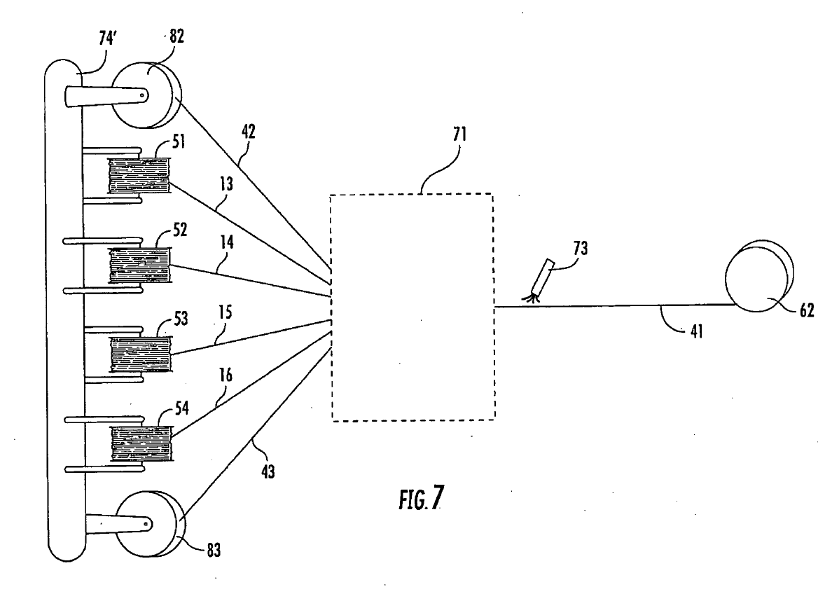

FIG. 7 is a schematic illustration of manufacturing equipment for creating the composite cable 41 of FIG. 5. As illustrated in FIG. 7, first through fourth jacketed cables 13-16 are being unspooled from first through fourth cable spools 51-54. Preformed outer jackets 42 and 43 are being unspooled from fifth and sixth spools 82 and 83, respectively. The first through sixth spools 51, 52, 53, 54, 82 and 83 are mounted to a ring 74′, which can optionally move. The first through fourth jacketed cables 13-16 and first and second outer jacket 42 and 43 are feed into the wrapping equipment 71, such as the known SZ stranding or twisting machine.

The SZ stranding machine helically twists the first and second outer jackets 42 and 43 around the first through fourth jacketed cables 13-16, and can also optionally twist the first through fourth jacketed cables 13-16 about themselves, if desired. SZ stranding machines have adjustments, such that the air gaps between the first and second helically wound strands of outer jackets 42 and 43 can be adjusted as desired.

Next, the first and second outer jackets 42 and 43 wrapping the composite cable 41 are optionally heated by one or more heat sources, such as flame streams 73 on the downstream side of the SZ stranding machine 71. The heat of the flame streams 73 causes the first and second outer jackets 42 and 43 to bond to each other and to the jackets of the inner jacketed cables 13-16, which are formed of a same or like material. Moreover, the heat sensitive adhesive layer 32 may also be provided on the spooled first and second outer jackets 42 and 43 to assist the bonding process.

After leaving the heat streams 73, the composite cable 41 is optionally passed though a cool water bath to cool the heated outer jacket 22, or directly spooled onto a take-up spool 62 for shipping to a customer or for later processing into customer packaging.

As an alternative, the heat sensitive layers 32 may be replaced by the pressure sensitive layers 32′. The SZ stranding machine may induce a certain level of tension on the first and second outer jackets 42 and 43 as they are wrapped about the inner jacketed cables 13-16. The tension can serve to activate the pressure sensitive layers 32′ on the inner surfaces 31 of the first and second outer jackets 42 and 43. In the alternative embodiment, the flame streams 73 and the cool water bath are not necessary. Rather, the composite cable 41 may be directly spooled onto the take-up spool 62 for shipping to a customer or for later processing into customer packaging.

The adhesion between the outer jacket 22 and the inner jacketed cables 13-16, and/or the adhesion between the second outer jacket 43 and the first outer jacket 42, and/or the basket weave pattern (dependent upon the embodiment of the invention) may be self-sufficient to prevent unraveling of the outer jacket(s) from the inner jacketed cables 13-16. The basket weave pattern is especially effective in preventing unraveling when more than two outer jackets 42 and 43 are employed. In such a case, the heat sensitive adhesive layer 32 or the pressure sensitive layer 32′ may be eliminated. Of course, the wrapping equipment 71 need not be a SZ stranding machine. Rather, known wrapping equipment with a rotating payoff or a rotating take-up, as discussed in conjunction with FIG. 6, may be used.

Although the figures describing the invention have illustrated two coaxial cables, one twisted pair cable and one fiber optic cable, the present invention is not limited to such a composite cable. For example, composite cables having only one coaxial cable, one twisted pair cable and three fiber optic cables may enjoy the benefits of one or more helically wound outer jackets. The type and number of the plural inner jacketed cables is ancillary to the benefits of the invention. Any type of jacketed cable may be included in the composite cable, such as low voltage alarm cables, speaker wires, and HAM radio cables.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

I claim:

1. A composite cable comprising:
a first jacketed cable;
a second jacketed cable; and
an outer containment element continuously wound about said first and second jacketed cables, wherein a surface of said outer containment element facing said first and second jacketed cables is at least partially adhered to said first and second jacketed cables.

2. The composite cable of claim 1, wherein said outer containment element is formed of a polymer material.

3. The composite cable of claim 1, further comprising:
a layer of contact or heat sensitive adhesive provided on said surface of said outer containment element facing said first and second jacketed cables.

4. The composite cable of claim 1, wherein adjacent wound strands of said outer containment element are spaced from one another so as to create a helix with air gaps exposing said first and second jacketed cables.

5. The composite cable of claim 4, wherein an outer appearance of said composite cable exhibits less than about 50% of a material used to form said outer containment element and more than about 50% air gaps exposing said first and second jacketed cables.

6. The composite cable of claim 1, further comprising:
indicia printed on said outer containment element indicating at least one of a manufacturer of said composite cable, a catalog number of said composite cable, a performance rating or type of one or more of said first and second jacketed cables, and length measurements along said composite cable.

7. The composite cable of claim 1, further comprising:
a third jacketed cable, wherein said outer containment element is also continuously wound about said third jacketed cable.

8. The composite cable of claim 7, wherein at least one of said first, second and third jacketed cables is a coaxial cable and at least one of said first, second and third jacketed cables is a fiber optic cable.

9. The composite cable of claim 7, wherein at least one of said first, second and third jacketed cables is a coaxial cable and at least one of said first, second and third jacketed cables is a twisted pair cable.

10. The composite cable of claim 7, wherein at least one of said first, second and third jacketed cables is a fiber optic cable and at least one of said first, second and third jacketed cables is a twisted pair cable.

11. The composite cable of claim 1, wherein said outer containment element has a width of about ¼ inch.

12. The composite cable of claim 1, wherein said outer containment element is a first helically wound outer containment element which is wound in a first rotating direction about said first and second jacketed cables, and further comprising:
a second helically wound outer containment element which is also wound about said first and second jacketed cables, but is wound in a second rotating direction about said first and second jacketed cables, wherein said second rotating direction is opposite to said first rotating direction.

13. A composite cable comprising:
a first jacketed cable;
a second jacketed cable;
a first outer containment element continuously wound about said first and second jacketed cables, which is wound in a first rotating direction about said first and second jacketed cables; and
a second outer containment element continuously wound about said first and second jacketed cables, which is wound in a second rotating direction about said first and second jacketed cables, wherein said second rotating direction is opposite to said first rotating direction.

14. The composite cable of claim 13, wherein said second outer containment element alternatively overlaps and underlaps said first outer containment element to create a basket weave pattern.

15. The composite cable of claim 14, wherein said basket weave pattern creates air gaps exposing said first and second jacketed cables.

16. The composite cable of claim 15, wherein an outer appearance of said composite cable exhibits less than about 50% of a material used to form said first and second outer containment elements and more than about 50% air gaps exposing said first and second jacketed cables.

17. A method of forming a composite cable comprising:
feeding a first jacketed cable from a first source;
feeding a second jacketed cable from a second source;
bringing the first and second jacketed cables into close proximity or abutment;
moving the first and second jacketed cables past wrapping equipment; and
feeding a preformed strip of outer containment material from a third source onto an external surface of the first and second jacketed cables in a helical manner so as to create strands of outer containment material winding around the first and second jacketed cables.

18. The method of claim 17, further comprising:
bonding the outer containment material to the first and second jacketed cables by heating the outer containment material prior to or after the outer containment material contacts the first and second jacketed cables;
cooling the outer containment material; and
feeding the thus formed composite cable to a storage area.

19. The method of claim 17, wherein said feeding the preformed strip of outer containment material step produces air gaps exposing the first and second jacketed cables between adjacent strands of the outer containment material.

20. The method of claim 17, wherein the performed strip of outer containment material is a first performed strip of first outer containment material, the method further comprising:
feeding a second preformed strip of second outer containment material onto an external surface of the first and second jacketed cables in a helical manner so as to create strands of the second outer containment material winding around the first and second jacketed cables.
